(19) United States
(12) Patent Application Publication
(10) Pub. No.: US 2021/0003858 A1
(43) Pub. Date: Jan. 7, 2021

(54) OPTICAL IMAGE FORMING DEVICE

(71) Applicant: MURAKAMI CORPORATION, Shizuoka (JP)

(72) Inventor: Masataka HAMANO, Shizuoka (JP)

(73) Assignee: MURAKAMI CORPORATION, Shizuoka (JP)

(21) Appl. No.: 16/968,679

(22) PCT Filed: Feb. 5, 2019
(86) PCT No.: PCT/JP2019/004052

§ 371 Date: Aug. 10, 2020

(30) Foreign Application Priority Data
Feb. 13, 2018 (JP) 2018-023151

(51) Int. Cl. G02B 30/56; G02B 5/00

(52) U.S. Cl. CPC G02B 30/56; G02B 1/11; G02B 5/003

(57) ABSTRACT

An optical image forming device according to the present disclosure includes: a display device that emits light to display information; an aerial image forming element that reflects light from the display device a plurality of times to display a virtual image; and a light direction regulating member that is arranged on an optical path from the display device to the aerial image forming element and regulates a direction of light emitted from the display device.

### TECHNICAL FIELD

The present disclosure relates to an optical image forming device that displays a virtual image.

### BACKGROUND ART

Japanese Unexamined Patent Publication No. 2015-166845 discloses a flat optical image forming element. The optical image forming element has one main surface that forms a light incident surface and the other main surface that forms a light emitting surface. The optical image forming element includes a plurality of light transmissive members each having a rectangular columnar shape. The optical image forming element is formed by arranging a plurality of light transmissive members in a matrix along each of the first direction and the second direction.

A reflective film is provided on one of the two side surfaces of each light transmissive member facing the first direction and on one of the two side surfaces of each light transmissive member facing the second direction. The arithmetic average roughness of each of the above-described side surfaces of each light transmissive member is set to 0.1 nm or less. As the reflective film, a metal film formed of a metal such as aluminum or silver, a multilayer film in which a high refractive index film having a relatively high refractive index and a low refractive index film having a relatively low refractive index are alternately laminated, and the like are used.

In the optical image forming element, each light transmissive member is surrounded by a reflective surface. For this reason, it is difficult for light to be incident on a portion of the reflective surface on the light emitting surface side, and most of the incident light is reflected by the reflective surface at the portion on the light incident surface side. Therefore, by making it difficult to emit the primary reflected light from the light emitting surface, it is possible to suppress a high-brightness ghost caused by the primary reflected light.

### CITATION LIST

### Patent Literature

Patent Literature 1: Japanese Unexamined Patent Publication No. 2015-166845

### SUMMARY OF INVENTION

### Technical Problem

Incidentally, as illustrated in FIG. 7, there is known an aerial image forming element 100 that displays an aerial floating image (virtual image) by reflecting light L20 emitted from a display device 101, such as a display, a plurality of times. The aerial image forming element 100 includes a plurality of light control panels 102, and each. light control panel 102 has a plurality of reflective surfaces 102a. Due to the display of the aerial floating image by the aerial image forming element 100, the aerial floating image is displayed as if the aerial floating image floats at a position plane-symmetrical with respect to the aerial image forming element 100.

In the aerial image forming element 100 described above, light L22 reflected twice by the reflective surface 102a of each light control panel 102 is emitted to the side of the aerial image forming element 100 opposite to the display device 101 to contribute to the formation of an aerial floating image. However, light L21 reflected once by the reflective surface 102a of one light control panel 102 among the plurality of light control panels 102 travels in the left-right direction along the in-plane direction of the light control panel 102. The light L21 traveling in the left-right direction may cause glare on both sides of the aerial floating image. As a result, a problem that the aerial floating image is difficult to see may occur.

It is an object of the present disclosure to provide an optical image forming device capable of suppressing glare and improving the visibility of an aerial floating image.

### Solution to Problem

An optical image forming device according to the present disclosure includes: a display device that emits light to display information; an aerial image forming element that reflects light from the display device a plurality of times to display a virtual image; and a light direction regulating member that is arranged on an optical path from the display device to the aerial image forming element and regulates a direction of light emitted from the display device.

The optical image forming device includes the aerial image forming element that reflects light from the display device, which displays information, a plurality of times to display a virtual image. Therefore, by displaying the virtual image on the front side of the display device, the virtual image can be displayed as an aerial floating image that floats on the front side. As a result, since the virtual image is displayed as an aerial floating image by the aerial image forming element, it is possible to increase the impact of the displayed information. In addition, the optical image forming device includes the light direction regulating member on the optical path between the display device and the aerial image forming element, and the light direction regulating member regulates the direction of the light emitted from the display device. Accordingly, by regulating the direction of the light emitted from the display device using the light direction regulating member, the traveling direction of the light incident on the aerial image forming element can be regulated. Therefore, the light from the display device can be prevented from traveling in the left-right direction along the in-plane direction of the aerial image fanning element. As a result, since it is possible to suppress glare that appears on both sides of the aerial floating image, the visibility of the aerial floating image can be improved.

The light direction regulating member may have a plurality of wall portions that block a part of the light emitted from the display device. In this case, a part of the light from the display device is blocked by the plurality of wall portions of the light direction regulating member. Therefore, the traveling direction of the light incident on the aerial image forming element can be more reliably regulated.

The optical image forming device may include an antireflection member that is provided on a side of the aerial image forming element opposite to the display device. In this case, the antireflection member is provided on the front side of the aerial image forming element when viewed from the user. Therefore, since the antireflection member is provided, the reflection of light on the front side of the aerial image forming element can be suppressed. As a result, the visibility of the aerial floating image can be further improved.

The optical image forming device may include an antiglare member that is provided on a side of the aerial image forming element opposite to the display device. In this case, the antiglare member is provided on the front side of the aerial image forming element when viewed from the user. Accordingly, since the antiglare member is provided, it is possible to improve the antiglare property by suppressing white blur or glare reflected on the front side of the aerial image forming element. Therefore, the visibility of the aerial floating image can be further improved.

Advantageous Effects of invention

According to the present disclosure, it is possible to suppress glare and improve the visibility of an aerial floating image.

### BRIEF DESCRIPTION OF DRAWINGS

FIG. 1 is a schematic configuration diagram illustrating an optical image forming device according to a first embodiment.

FIG. 2 is a cross-sectional view illustrating a light direction regulating member and a display device of the optical image forming device illustrated in FIG. 1.

Part (a) of FIG. 3 is a diagram showing a simulation result of an image by the optical image forming device including the light direction regulating member illustrated in FIG. 2.

Part (b) of FIG. 3 is a diagram showing a simulation result of an image by an optical image forming device as a comparative example having no light direction regulating member.

FIG. 4 is a schematic configuration diagram illustrating an optical image forming device according to a second embodiment.

FIG. 5 is a cross-sectional view illustrating a light direction regulating member and a display device of an optical image forming device according to a third embodiment.

Part (a) of FIG. 6 is a plan view schematically illustrating a display device of an optical image forming device according to a fourth embodiment.

Part (b) of FIG. 6 is a side view schematically illustrating collimator lenses of the display device illustrated in the part (a) of FIG. 6.

FIG. 7 is a perspective view schematically illustrating an aerial image forming element of a conventional optical image firming device.

### DESCRIPTION OF EMBODIMENTS

Hereinafter, embodiments of an optical image forming device according to the present disclosure will be described with reference to the diagrams. In the description of the diagrams, the same or equivalent elements are denoted by the same reference numerals, and repeated description thereof will be omitted. For ease of understanding, parts of the diagrams are simplified or exaggerated, and the dimensional ratios and the like are not limited to those described in the diagrams.

### First Embodiment

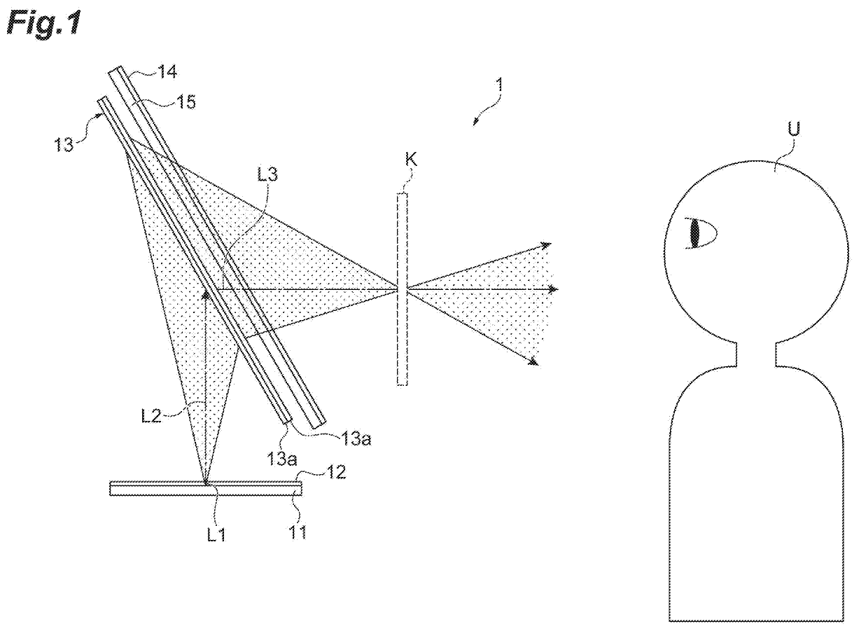

FIG. 1 illustrates an optical image forming device 1 according to a first embodiment. For example, the optical image forming device 1 is mounted in a vehicle, such as a car. As an example, the optical image forming device 1 displays vehicle information regarding the vehicle such as speed information, route information such as information of a route toward the destination, and risk information including the presence or absence of a pedestrian near the vehicle, and may further display other pieces of information. The optical image forming device 1 provides information for a user U in a more user-friendly form so that the information can be easily understood.

The optical image forming device 1 includes a display device 11 such as a monitor, a light direction regulating member 12 that regulates the direction of light L1 from the display device 11, an aerial image forming element 13 that receives light L2 from the light direction regulating member 12 and displays a virtual image K, an antireflection member 14 provided on the downstream side of the optical path of light L3 emitted from the aerial image forming element 13, and a glass plate 15 to which the antireflection member 14 is bonded.

The display device 11 is, for example, a liquid crystal panel capable of displaying the above-described information. The display device 11 may be a display of a PC (personal computer), a tablet terminal, or a mobile terminal such as a mobile phone. The aerial image forming element 13 displays an image of the display device 11 as the virtual image K at a position in front of the aerial image forming element 13 and the display device 11 (that is, the user U side).

The aerial image forming element 13 includes two light control panels 13a. For example, the light L2 emitted upward from the light direction regulating member 12 and incident on the aerial image forming element 13 is reflected twice by the aerial image forming element 13. The aerial image forming element 13 forms the virtual image K in a space located on the user U side by reflecting the light L2 twice. Since the thickness of each light control panel 13a is, for example, about 1.5 mm, the thickness of the aerial image forming element 13 is about 3.0 mm. As described above, since the position where the virtual image K is formed is a position closer to the user U than to the display device 11 and the aerial image forming element 13, the virtual image K can be easily recognized. The aerial image forming element 13 is, for example, an AI (Aerial imaging) plate (registered trademark) for forming an image in the air, and the AI plate is manufactured using the technique described in Japanese Patent No. 4865088.

The antireflection member 14 is, for example, a film member having an AR (Anti Reflection) coating. The antireflection member 14 is, for example, an antireflection film bonded to the user U side of the glass plate 15. The antireflection member 14 is manufactured, for example, by coating a base film, on which a hard coat layer is formed, with a dielectric multilayer film. The antireflection member 14 is provided to prevent reflection of light from the side opposite to the aerial image forming element 13 (that is, the user U side). The antireflection member 14 can suppress the reflected light from traveling to the user U.

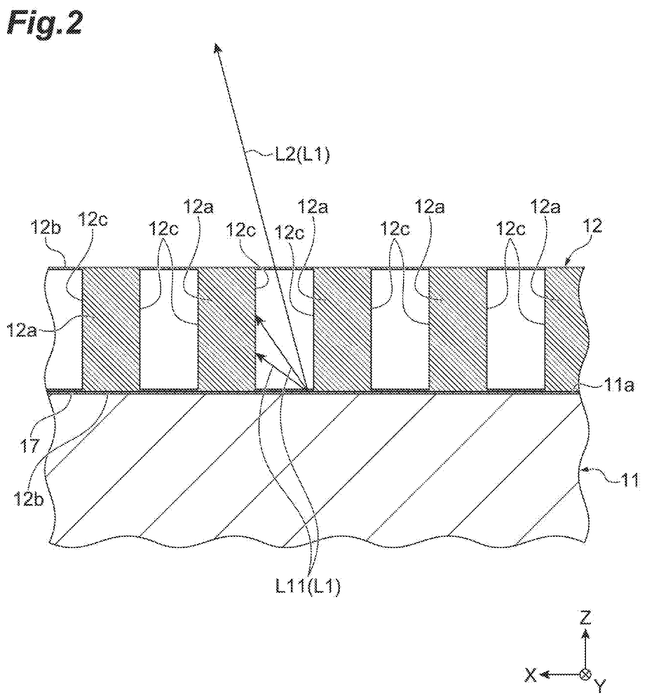

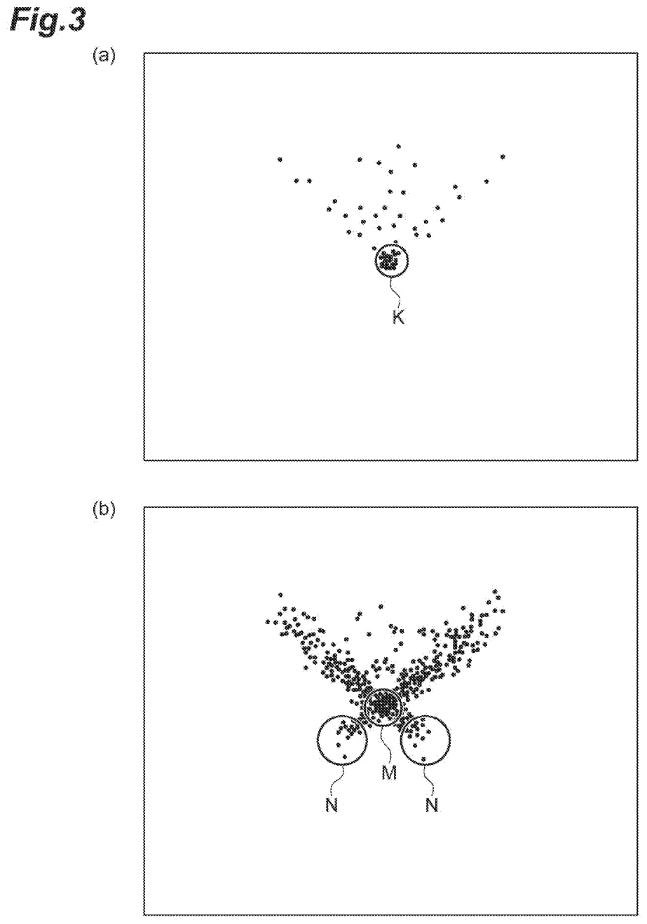

As illustrated in FIGS. 1 and 2, the light direction regulating member 12 is bonded to a surface 11a of the display device 11 facing the aerial image forming element 13 side with an adhesive 17, for example. The adhesive 17 may be, for example, an optical clear adhesive (OCA) or an optical clear adhesive resin (OCR). The refractive index of light of the adhesive 17 is approximately the same as the refractive index of glass, for example.

The light direction regulating member 12 may be bonded to the entire surface 11a, or may be partially bonded to the surface 11a such as the outer edge of the surface 11a. The light direction regulating member 12 may be bonded by means other than the adhesive 17, such as a double-sided tape. The light direction regulating member 12 may not be bonded to the surface 11a, and may be fixed on the surface 11a by a fixing member, for example. In this manner, the arrangement of the light direction regulating member 12 can be appropriately changed.

The following description will be given on the assumption that a direction in which the light direction regulating member 12 is provided with respect to the display device 11 is a Z direction, a direction along a plane perpendicular to the Z direction is an X direction, and a direction perpendicular to both the Z direction and the X direction is a Y direction. However, these directions are for convenience of description and do not limit the scope of the present disclosure.

The light L1 from the display device 11 is emitted as divergent light from the surface 11a facing the Z direction and is incident on the light direction regulating member 12. The light direction regulating member 12 has a plate shape extending in the X direction and the Y direction. The thickness (for example, the length in the Z direction) of the light direction regulating member 12 is, for example, 0.1 mm or more and 0.8 mm or less, preferably 0.2 mm or more and 0.6 mm or less, and more preferably 0.4 mm. Since the thickness of the light direction regulating member 12 is 0.1 mm or more, it is possible to reliably regulate the direction of light, Since the thickness of the light direction regulating member 12 is 0.8 mm or less, it is possible to suppress a reduction in the amount of the light L2 (that is, a reduction in the brightness of the virtual image K).

The light direction regulating member 12 includes a plurality of wall portions 12a, which absorb a part of the light L1 from the display device 11, and a main surface portion 12b provided in each of the plurality of wall portions 12a in the Z direction. The main surface portion 12b has a flat shape along the X direction and the Y direction. As an example, the light direction regulating member 12 is a louver film. The plurality of wall portions 12a are arranged, for example, side by side along the X direction. Each wall portion 12a has a light absorbing surface 12c extending in the Z direction. Each wall portion 12a extends linearly in the Y direction. Of the pair of main surface portions 12b, one main surface portion 12b faces the surface 11a, and the other main surface portion 12b is exposed to the aerial image forming element 13 side.

Of the light L1 that is divergent light from the display device 11, light L11 whose angle with respect to the Z direction is larger than a predetermined value is blocked by each of the plurality of wall portions 12a (specifically, the light absorbing surface 12c), and the light L2 whose angle with respect to the Z direction is equal to or less than the predetermined value is emitted from the light direction regulating member 12. As described above, each of the plurality of wall portions 12a blocks the light L11 and emits only the light L2, so that the light L2 having the regulated angle can be emitted. The light absorbing surface 12c may not absorb all components of the light L11, or may reflect a part of the light L11.

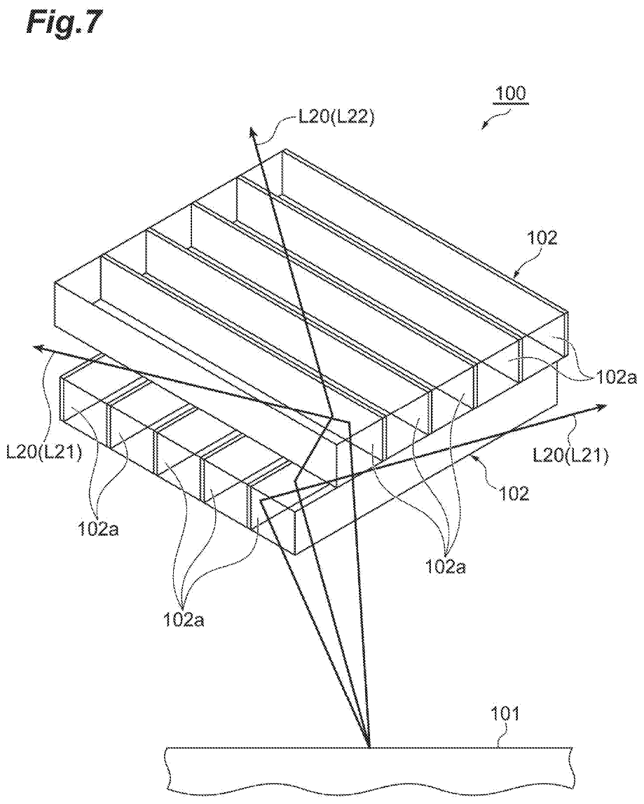

Incidentally, if the divergent light of the display device is directly incident on the aerial image forming element, light in all directions is incident on the aerial image forming element. When light in all directions is incident on the aerial image forming element, light that should originally be reflected twice on the aerial image forming element but is reflected only once may be generated (refer to the light L21 in FIG. 7). The light that is reflected only once on the aerial image forming element travels in the left-right direction along the in-plane direction of the light control panel, and this may cause glare.

Specifically; as shown in the simulation result of a part (b) of FIG. 3, the light that is reflected only once on the aerial image forming element travels in the left-right direction along the in-plane direction of the light control panel, and glare N may appear on both sides of a virtual image M, which is an aerial floating image, due to the light traveling in the left-right direction. The appearance of the glare N described above may cause a problem that the virtual image M is difficult to see. On the other hand, in the optical image forming device 1 according to the present embodiment, the above-described problems are solved. Specifically; the following operational effects are achieved.

Hereinafter, the operational effect of the optical image forming device 1 according to the present embodiment will be described. As illustrated in FIGS. 1 and 2, the optical image forming device 1 includes the aerial image forming element 13 that displays the virtual image K by reflecting the light L2, which is emitted from the display device 11 for displaying information through the light direction regulating member 12, a plurality of times. Therefore, by displaying the virtual image K on a side closer to the user U at a position plane-symmetrical with respect to the aerial image forming element 13, the virtual image K can be displayed as an aerial floating image that floats on the front side. As a result, since the virtual image K is displayed as an aerial floating image by the aerial image forming element 13, it is possible to increase the impact of the displayed information.

In addition, the optical image forming device 1 includes the light direction regulating member 12 in the optical path between the display device 11 and the aerial image forming element 13, and the light direction regulating member 12 regulates the direction of the light L emitted from the display device 11. Accordingly, by regulating the direction of the light L1 emitted from the display device 11 using the light direction regulating member 12, the traveling direction of the light L2 incident on the aerial image forming element 13 can be regulated. Therefore, the light from the display device 11 can be prevented from traveling in the left-right direction along the in-plane direction of the aerial image forming element 13. As a result, as shown in a part (a) of FIG. 3, it is possible to suppress glare that appears on both sides of the virtual image K that is an aerial floating image, so that the visibility of the aerial floating image can be improved.

The part (a) of FIG. 3 shows a simulation result when one light direction regulating member 12 is arranged. Even if two or more light direction regulating members 12 are arranged, the same effect as in the part (a) of FIG. 3 can be obtained. Specifically, the same effect can be obtained even when two light direction regulating members 12 in which a plurality of wall portions 12a extend in the same direction are arranged so as to overlap each other, when two light direction regulating members 12 in which a plurality of wall portions 12a extend in directions perpendicular to each other are arranged so as to overlap each other, and when two light direction regulating members 12 in which a plurality of wall portions 12a extend in directions shifted from each other by 45° are arranged so as to overlap each other.

However, when the two light direction regulating members 12 are arranged so as to overlap each other, the virtual image K is displayed slightly thin. On the other hand, when one light direction regulating member 12 is arranged, glare on both sides of the virtual image K can be suppressed, and the virtual image K can be clearly displayed by increasing the brightness. As a result, since the visibility of the virtual image K can be reliably maintained, the visibility can be further improved eventually.

The light direction regulating member 12 has a plurality of wall portions 12a that block a part of the light L1 emitted from the the display device 11. Accordingly, a part of the light L1 from the display device 11 is blocked by the plurality of wall portions 12a of the light direction regulating member 12. Therefore, the traveling direction of the light L2 incident on the aerial image forming element 13 can be more reliably regulated.

The optical image forming device 1 includes the antireflection member 14 provided on the side of the aerial image forming element 13 opposite to the display device 11. That is, the antireflection member 14 is provided on the front side of the aerial image forming element 13 when viewed from the user U. Therefore, since the antireflection member 14 is provided, the reflection of light on the front side of the aerial image forming element 13 can be suppressed. As a result, the visibility of the aerial floating image can be further improved.

### Second Embodiment

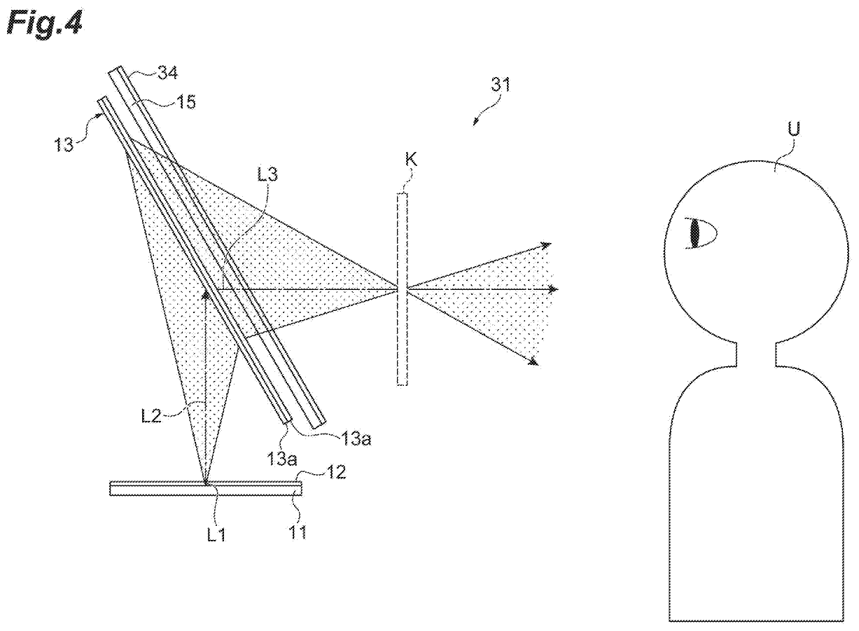

Next, an optical image forming device according to a second embodiment will be described with reference to FIG. 4. An optical image forming device 31 according to the second embodiment includes an antiglare member 34 instead of the antireflection member 14. The antiglare member 34 is bonded to, for example, the glass plate 15, similarly to the antireflection member 14. In the following description, description overlapping the first embodiment will be appropriately omitted.

The antiglare member 34 is, for example, a film member formed of a material subjected to AG (Anti Glare) treatment. The antiglare member 34 may have irregularities on the surface. In this case, the irregularities can make it possible to diffuse light to suppress glare. In this manner, the antiglare member 34 diffuses incident light to suppress the glare of the image and improve the sharpness of the image.

As described above, the optical image forming device 31 according to the second embodiment includes the antiglare member 34 provided on the side of the aerial image forming element 13 opposite to the display device 11. The antiglare member 34 is provided on the front side of the aerial image forming element 13 when viewed from the user U. Accordingly, since the antiglare member 34 is provided, it is possible to improve the antiglare property by suppressing white blur or glare reflected on the front side of the aerial image thrilling element 13.

Therefore, the visibility of the aerial floating image can be further improved. It is also possible to use the antiglare member 34 together with the antireflection member 14 of the first embodiment.

### Third Embodiment

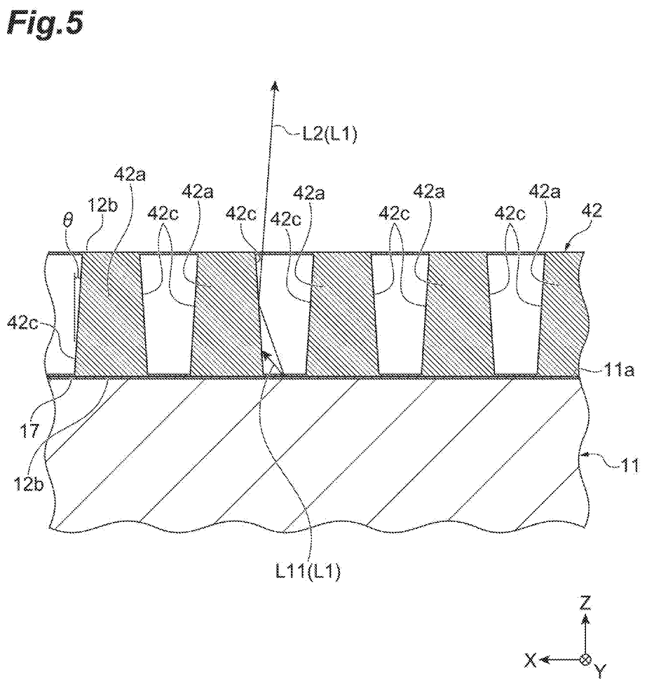

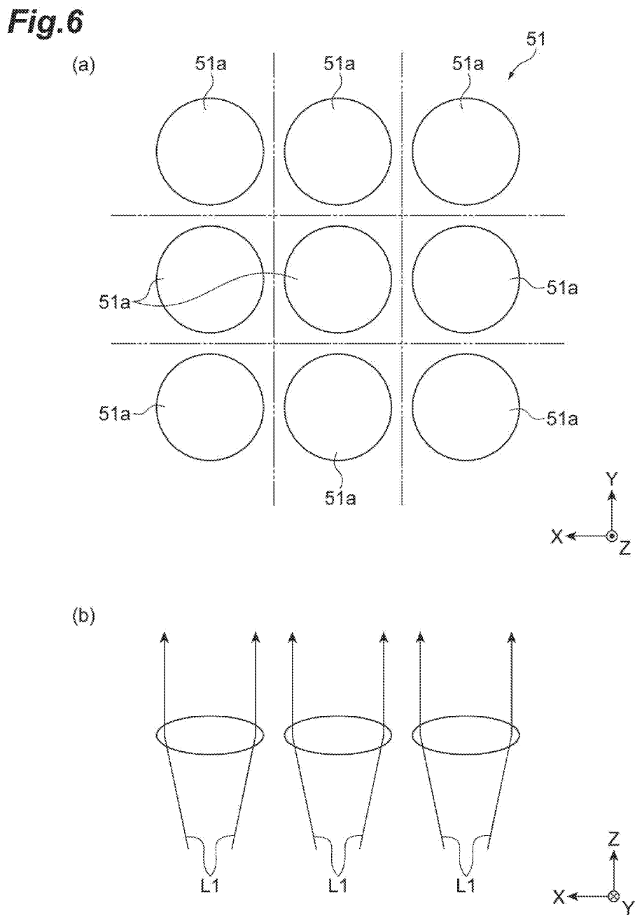

Next, an optical image forming device according to a third embodiment will be described with reference to FIG. 5. In the optical image forming device according to the third embodiment, the configuration of a wall portion 42a of a light direction regulating member 42 is different from that of the first embodiment. The light direction regulating member 42 includes a plurality of wall portions 42a arranged along the X direction and the main surface portion 12b described above. Each wall portion 42a has a light reflection surface 42c that is inclined with respect to the Z direction. For example, the light reflection surface 42c is inclined in a direction in which the wall portion 42a becomes thinner along the Z direction, and the inclination angle θ of the light reflection surface 42c with respect to the Z direction is greater than 0° and 15° or less. The light reflection surface 42c reflects the light L2, which is a part of the light L1 from the display device 11, and absorbs the remaining light L11 of the light L1.

As described above, the light direction regulating member 42 of the optical image forming device according to the third embodiment has a plurality of wall portions 42a including the light reflection surface 42c that reflects a part of the light L1 emitted from the display device 11, and each light reflection surface 42c is inclined with respect to the thickness direction (Z direction) of the light direction regulating member 42. Accordingly, since the traveling direction of the light L2 can be regulated and the reflected light L2 can be emitted, the virtual image K can be displayed more clearly by increasing the amount of the light L2 to increase the brightness. Therefore, the visibility of the virtual image K can be further improved.

### Fourth Embodiment

Next, an optical image forming device according to a fourth embodiment will be described with reference to parts (a) and (b) of FIG. 6. In the optical image forming device according to the fourth embodiment, the configuration of a display device 51 is different from that of each of the embodiments described above. The display device 51 is a display having a higher brightness than the display device 11 described above. As illustrated in the parts (a) and (b) of FIG. 6, the display device 51 is a liquid crystal display, and includes a plurality of microlenses 51a. A plurality of rnicrolenses 51a are provided, for example, for respective pixels of the display device 51, and are arranged in a grid pattern. That is, the microlens 51a is arranged for each liquid crystal of the display device 51. Each microlens 51a converts the light L1 that is divergent light into parallel light, and emits the light L1 converted into parallel light to the light direction regulating member.

As described above, in the optical image forming device according to the fourth embodiment, the display device 51 includes a plurality of microlenses 51a, and each microlens 51a emits the light L1 as parallel light to the light direction regulating member. Accordingly, since the direction of the light L1 can be regulated before the light L1 is incident on the light direction regulating member, it is possible to increase the amount of the light L2 emitted from the light direction regulating member toward the aerial image forming element. Therefore, since the virtual image K can be displayed more clearly, the visibility of the virtual image K can be further improved.

Each embodiment of the optical image forming device according to the present disclosure has been described above. However, the present disclosure is not limited to the above-described embodiments, and may be modified or applied to other things without departing from the scope described in the claims. That is, the configuration of each unit of the optical image fanning device can be appropriately changed without departing from the scope of the claims.

For example, in the above-described embodiments, as illustrated in FIGS. 1 and 4, the optical image forming device including the antireflection member 14 and the optical image forming device 31 including the antiglare member 34 have been described. However, in the optical image forming device, instead of the antireflection member 14 and the antiglare member 34, an anti-fingerprint member (Anti Finger) that prevents stains due to fingerprints may be bonded to the glass plate 15. The anti-fingerprint member may have a function of making fingerprints less noticeable and easier to wipe off, or may be a fingerprint erasing member for removing adhered fingerprints.

The anti-fingerprint member may be formed by applying a fingerprint-resistant coating additive (or a fingerprint anti-sticking agent) to the surface of a film-shaped substrate. Among the functional films including the antireflection member 14, the antiglare member 34, and the anti-fingerprint member described above, a plurality of arbitrary members may be bonded to the glass plate 15. In addition, at least one of the antireflection member 14, the antiglare member 34, and the anti-fingerprint member may be bonded to the aerial image forming element 13 instead of the glass plate 15. In this case, the glass plate 15 can be omitted.

In the above-described embodiments, an example in which the light direction regulating member 12 is a louver film has been described. However, the light direction regulating member may be a member other than the louver film. For example, the light direction regulating member may be a member which has a plurality of holes and in which a part of the inner surface of each hole is a light absorbing surface and the remaining part is a light reflection surface, and the configuration of the light direction regulating member can be appropriately changed.

In the above-described embodiments, an example in which the aerial image limning element 13 is an AI plate for forming an image in the air has been described. However, the aerial image forming element may be, for example, a three-dimensional image forming element that forms a three-dimensional virtual image on the front side when viewed from the user U, or may be an element other than the AI plate.

In the above-described embodiments, the optical image funning device 1 including the display device 11, the light direction regulating member 12, the aerial image forming element 13, the antireflection member 14, and the glass plate 15 has been described. However, the type, shape, size, number, material, and arrangement of the display device, the light direction regulating member, the aerial image forming element, the antireflection member, and the glass plate can be appropriately changed. In addition, in the above-described embodiments, the optical image forming device 1 mounted in a vehicle, such as a car, has been described. However, the optical image forming device can also be applied to various devices other than the vehicle.

### REFERENCE SIGNS LIST

1, 31: optical image forming device, 11, 51: display device, 12, 42: light direction regulating member, 12a, 42a: wall portion, 13: aerial image forming element, 14: antireflection member, 34: antiglare member, K: virtual image, L1, L2, L3, L11: light.

1. An optical image forming device, comprising:
a display device that emits light to display information;
an aerial image forming element that reflects light from the display device a plurality of times to display a virtual image; and
a light direction regulating member that is arranged on an optical path from the display device to the aerial image forming element and regulates a direction of light emitted from the display device.

2. The optical image forming device according to claim 1,
wherein the light direction regulating member has a plurality of wall portions that block a part of the light emitted from the display device.

3. The optical image forming device according to claim 1, further comprising:
an antireflection member that is provided on a side of the aerial image forming element opposite to the display device.

4. The optical image forming device according to claim 1, further comprising:
an antiglare member that is provided on a side of the aerial image forming element opposite to the display device.
